(19) United States
(12) Patent Application Publication
(10) Pub. No.: US 2009/0000431 A1
(43) Pub. Date: Jan. 1, 2009

(54) TOOL TO ADJUST THE CASTER AND CAMBER WHEEL ALIGNMENT OF A MOTOR VEHICLE

(75) Inventors: Larry R. Baca, Corrales, NM (US); Kevin L. Tally, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/768,376

(22) Filed: Jun. 26, 2007

(51) Int. Cl. B25F 1/00

(52) U.S. Cl. 81/437; 29/273

(57) ABSTRACT

A tool for adjusting the position of a control arm of a steering assembly in a vehicle and thereby set caster and camber includes a generally cylindrical body with a pin projecting from one side that is not coaxial with the body but which includes an axis generally parallel to the body axis. The body further includes a drive socket opening in the side opposite the projecting pin.

### BACKGROUND OF THE INVENTION

In a principal aspect the present invention relates to a tool used to enable adjustment of caster and camber wheel alignment settings for a vehicle.

Certain motor vehicles and, in particular, various trucks which have a wheel mounting assembly attached to the frame of the vehicle achieve desired caster and camber settings by adjusting the position of the lower control arm of the wheel mounting assembly relative to the frame and then tightening bolts which fix the adjusted position of the control arm relative to the vehicle frame.

That is, the control arm of a motor vehicle is attached to the frame of the vehicle by means of a slide bracket that may be adjusted by loosening bolts which hold the slide bracket tightly to the frame of the vehicle. Loosening of those bolts enables repositioning of the slide bracket and thereby repositioning of the control arm to effect desired correction to caster and camber. After the slide bracket is appropriately positioned, the bolts attaching the slide bracket to the frame can be retightened and the desired caster and camber of the vehicle is then achieved and maintained.

The particular methodology for mechanics to effect the loosening of the bolts which attach the mounting slide bracket for the lower control arm, effect adjustment of the slide bracket with respect to the frame and retightening of the fasteners or bolts is described at www.motoralldata.com. The noted reference is incorporated herewith by reference.

Mechanics and technicians engaged in effecting such adjustment typically have no special tool for adjusting the slide bracket of the control arm, particularly the lower control arm, relative to the frame. Rather, they may loosen the bolts holding the slide bracket to the frame and then adjust the slide bracket using a pry bar or similar tool. This procedure is difficult to effect and does not assure that the slide bracket will be maintained in the desired position relative to the frame of the vehicle prior to retightening the bolts that hold the lower control arm slide bracket in position relative to the vehicle frame. Moreover, such an adjustment is typically effected when the vehicle is on a lift. Consequently, when the vehicle is removed from the lift and the weight of the vehicle placed on the wheels, the settings made may not be correct. Thus, there has developed a need to provide a means and a tool which will enable desired adjustment of the position of a control arm relative to the frame of a vehicle in a way which insures that the adjustment will be maintained as the bolts attaching the slide bracket of the wheel control arm to the frame are tightened.

### SUMMARY OF THE INVENTION

Briefly, the present invention comprises a tool for effecting and maintaining adjustment of the position of the slide bracket of a wheel mounting assembly control arm for a vehicle to thereby set the caster and camber for a wheel mounted by the assembly. The tool includes a generally cylindrical body having a longitudinal axis. The body has an outer diameter which is substantially equal to the diameter of circular openings in the frame which are each generally aligned with an elongate opening in the bracket. The body further includes a pin extending from one end thereof which projects axially and generally parallel to the axis of the body but offset from the longitudinal axis. The pin is configured to fit into the elongate or non-circular opening in the slide bracket. The body further may include, on the side opposite the projecting pin, a planar face transverse to the axis with an axial socket opening in the surface. The socket opening is generally co-axial with the axis of the body. Alternatively, other means may be utilized to rotate the body about its axis such as a radial arm.

In use, the tool is positioned so that the pin will fit into the non-circular opening in the control arm. The circular body of the tool will simultaneously be positioned within the circular opening of the frame since the circular opening is generally aligned with the opening in the control arm. The opening in the slide bracket is typically non-circular and within the profile of the frame opening. The slide bracket opening may, for example, be elongate with dimensions chosen to receive the projecting pin of the tool. Typically, a tool is utilized in one of the two openings in the frame and the slide bracket depending on the type of adjustment that is needed. Thus, the frame will typically include two associated circular openings each aligned generally with an associated bracket opening. A socket driver may then be positioned within the socket opening in the tool to adjust the position of the slide bracket of the control arm relative to the frame. In this manner, the control arm may be precisely positioned and the bolts which attach the slide bracket to the frame may then be tightened. Subsequently, the tool may be removed from the assembly.

Thus, it is an object of the invention to provide an improved tool for adjusting the position of a control arm and thereby the caster and camber of an associated wheel assembly for a motor vehicle.

Yet another object of the invention is to provide a method for adjustment of a control arm relative to a frame of a motor vehicle by means of a tool which is rugged, easy to use and inexpensive.

Another object of the invention is to provide a tool for adjustment of a wheel mounting bracket on a frame when the weight of the vehicle is resting on the vehicle wheels.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view depicting the environment associated with the use of a tool and more particularly the lower control arm of a motor vehicle as attached to the frame of a vehicle;

FIG. 2 is an isometric view which is enlarged and depicts in greater detail the position of the frame and associated control arm for a wheel assembly in a motor vehicle;

FIG. 3 is an isometric view of an embodiment of the tool of the invention being positioned into engagement with the frame and control arm slide bracket of a motor vehicle;

FIG. 4 is an isometric view depicting the tool in position engaging the frame and control arm slide bracket of a motor vehicle;

FIG. 5 is an isometric view depicting an embodiment of the tool;

FIG. 6 is a top plan view of the tool of FIG. 5;

FIG. 7 is a side elevation of the tool of FIG. 6 which is partially cut away to provide a cross sectional view along a center line axis of the tool; and

FIG. 8 is an opposite end view of the tool of FIG. 6.

### DESCRIPTION OF AN EMBODIMENT OF THE INVENTION

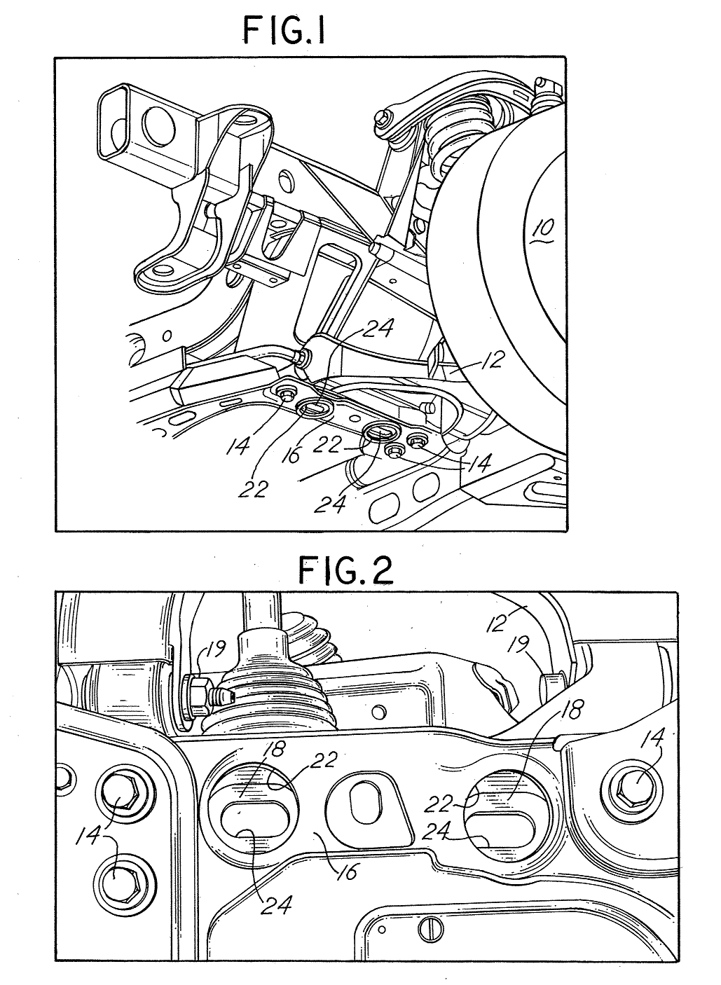

Referring to the figures, FIGS. 1 and 2 depict the environment associated with the use of the tool of the invention. Thus, a wheel assembly 10 of a motor vehicle includes a lower control arm 12 which is attached by fasteners 19 to the slide bracket 18 which is attached by bolts 14 to the frame 16 of the vehicle. Adjustment of the attachment of the arm 12 to the frame 16 may be effected by loosening of the bolts 14 and repositioning the attachment of the arm 12, more particularly slide bracket 18 of the lower control arm 12, relative to the frame 16. Upon adjustment of the position of bracket 18, the bolts 14 may be retightened to maintain the desired setting of caster and camber.

Heretofore, in order to effect the adjustment of the slide bracket 18 of the control arm 12 with respect to the frame 16, a pry bar, for example, would be inserted through circular openings 22 in the frame and engage the elliptical or oblong openings 24 in the slide bracket 18. The pry bar could then be manipulated to effect the adjustment. The bolts 14 which have been loosened would then be retightened. Maintaining the setting of the slide bracket 18 relative to the frame 16 is not assured with such methodology.

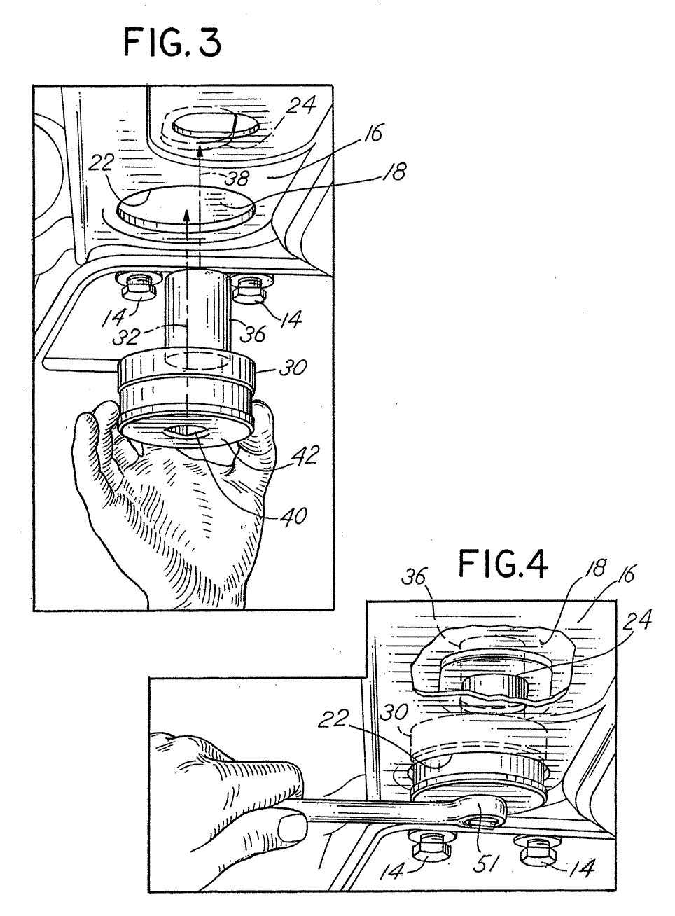

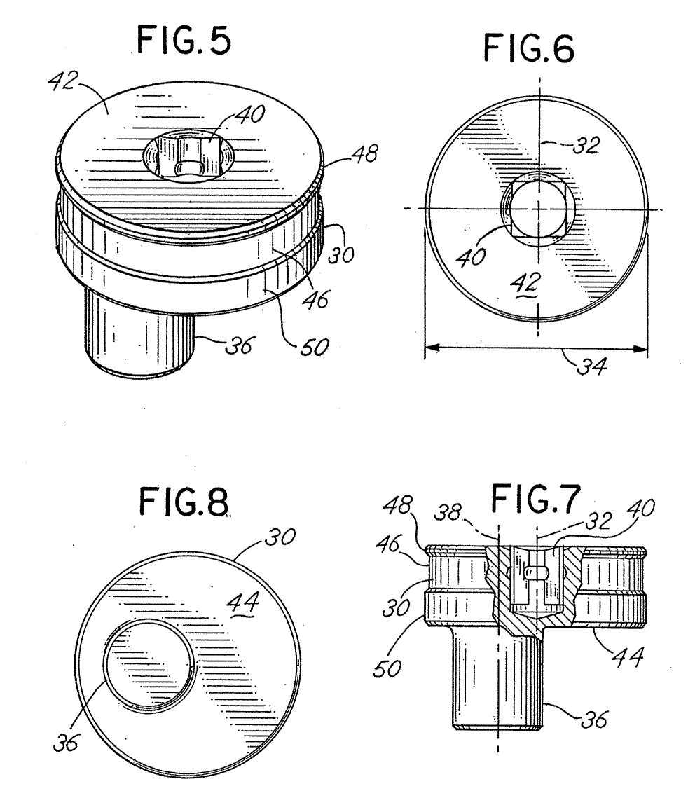

Therefore, a tool as depicted in the remaining FIGS. 3-8 can be utilized to more effectively assure the appropriate setting of the slide bracket 18 of the control arm 12 relative to the frame 16. The tool which is depicted in greater detail in FIGS. 5-8 is comprised of a main cylindrical body 30 having a central axis 32 and a diameter 34. The tool further includes a projecting pin 36 having, in the embodiment depicted, a generally cylindrical configuration and an axis 38 which is generally parallel to the axis 32 and offset laterally therefrom. The diameter of the projecting pin 36 is less than the diameter of the body 30. The diameter of the pin 36 is chosen so that the pin 36 may fit into the oblong or elongate slot or opening 24 in a slide bracket 18 of a control arm 12. Thus, the diameter of pin 36 is generally, slightly less than the spacing of the parallel side walls of the elongate slot 24 in the slide bracket 18 of the control arm 12.

The diameter 34 of the body 30 is generally slightly less than the diameter of the circular opening 22 in the frame 16. Thus, the body 30 may be fitted into the circular opening 22 of the frame 16 as the projecting pin 36 is fitted into the elongate slot 24 of the slide bracket 18.

The tool further includes a coaxial socket opening 40 coaxial with the axis 32 and extending inwardly into the body 30 from a generally flat planar surface 42 to enable effective receipt of a socket drive. The surface 42 is generally transverse to the axis 32. The body 30 includes an additional inside or lower surface 44 generally parallel to and spaced from the surface 42. The particular configuration of the surfaces 44 may be adjusted though a flat planar configuration is generally preferred.

An annular slot or channel 46 may be formed in the outer periphery of the body 30 to facilitate maintaining the tool within the opening 22 in the frame 16 during use of the tool. That is, the channel 46 is defined by flanges 48 and 50 which facilitate maintaining the tool appropriately aligned longitudinally within the opening 22 of a frame 16.

In use, the tool is positioned with the body 30 in the circular opening 22 of a frame 16 and the projecting pin 36 positioned in an elongate channel 24 of a slide bracket 18 associated with a control arm 12. The positioning may be effected prior to or subsequent to loosening of bolts 14. One or two tools may be utilized in order to effect the desired movement of the slide bracket 18 associated with the control arm 12. In any event, upon positioning of the tool in combination with the frame 16 and the slide bracket 18, the bolts 14 may be loosened. A socket drive 51 FIG. 3) may then be attached to the tool to effect rotation of the body 30 and the simultaneous engagement of the projecting pin 36 with the elongate slot 24 of the slide bracket 18 to thereby effect desired positioning of the control arm 12 and thereby adjust caster and camber. Also, various means may be adopted to engage and rotate the tool such as an integral radial arm extending from the body 30 or lever arm which fits onto an axial pin projecting from surface 42. As indicated, one or two tools may be used to simultaneously effect the appropriate and desired positioning of the control arm 12. In this manner, the caster and camber of a wheel associated with a motor vehicle may be appropriately adjusted.

While there has been set forth an embodiment of the invention, it is to be understood that the invention is to be limited only by the following claims and equivalents thereof. For example, the configuration and shape of the projecting pin 36 may be altered. Similarly, the cylindrical body 30 may be replaced by forms which are generally equivalent thereto so as to permit rotation of the tool in the frame of a motor vehicle. For example, a handle (not shown) may be affixed to the body 30 extending radially therefrom and attached to the top surface 42. The socket opening may be square or another non-circular shape. The outer face of the tool could be extended and non-circular thereby being compatible with a socket device or the like. Various other alternatives may be adopted including, for example, an over extending flange along the top face of the tool associated with the surface 42 to limit the insertion of the tool into the opening in the frame. Thus, the invention is limited only by the following claims and equivalents thereof.

1. A tool for adjusting the position, relative to a vehicle frame, of a control arm of a steering assembly for said vehicle to set the caster and camber for a wheel mounted by the control ann, said control arm attached to a slide brackets, said slide bracket attached to the frame by fasteners and including at least one opening aligned generally with a larger circular opening in the frame; said tool comprising in combination:
a generally cylindrical body having an outside face with an outside diameter substantially equal to the diameter of a circular opening in the frame, said body having a centerline axis, a generally flat planar top end transverse to the centerline axis, and a bottom end;
a pin projecting from said bottom end of the body with a pin axis parallel to and offset from the central axis and configured to fit into the said opening of a control arm slide bracket; and
said body top end including a drive element aligned with the centerline axis for rotating the body about the centerline axis thereof.

2. The tool of claim 1 wherein the drive element includes a socket drive opening in the top end, said socket drive opening aligned with the central axis.

3. A method for adjusting the caster and/or camber of a motor vehicle control arm mounted on a slide bracket by fasteners by means of a tool as set forth in claim 1 comprising the steps of:
(a) loosening the fasteners attaching the slide bracket to the frame member;
(b) placing a tool of claim 1 in the circular opening of the frame with the pin thereof projecting into the associated slide bracket opening;
(c) rotating the tool in the frame opening to adjust the caster and/or camber as desired; and
(d) tightening the fasteners to fix the slide bracket to the frame member.

4. The method of claim 3 wherein the step of rotating the tool is effected by means of a socket tool engaged with said drive element.

5. The tool of claim 1 further including a circumferential channel comprising the outside face.

6. The tool of claim 2 including a circumferential channel comprising the outside face.

7. A method for adjusting the caster and/or camber of a motor vehicle control arm mounted on a slide bracket which is attached by fasteners to said motor vehicle frame said slide bracket including at least one opening aligned with a larger circular opening in the frame, said method including the steps of:
(a) providing a tool having a generally cylindrical body with an outside diameter substantially equal to the diameter of said circular opening in the frame, said body having a centerline axis, a bottom side with a pin projecting from the bottom side, said pin having an axis parallel to and offset from the centerline axis and configured to fit into the opening of a control arm slide bracket, and a top side opposite the projecting pin said top side including a generally transverse drive element coaxial with the centerline axis to enable rotating the body about the centerline axis;
(b) loosening the fasteners attaching the slide bracket to the frame member;
(c) placing said tool body in the circular opening of the frame with the projecting pin fitted into the associated slide bracket opening;
(d) rotating the tool body in the frame opening to adjust the caster and/or camber as desired; and
(e) tightening the fasteners to fix the slide bracket to the frame member.

8. The method of claim 7 wherein the step of rotating the tool body is affected by means of a socket tool engaged with a drive element opening in the top side of the tool.
